(19) United States
(12) Patent Application Publication
(10) Pub. No.: US 2025/0046155 A1
(43) Pub. Date: Feb. 6, 2025

(54) GAME TO PREDICT INTERMEDIATE RESULTS OF SPORTING CONTEST, SUCH AS RESULTS OF CURRENT OFFENSIVE DRIVE IN A FOOTBALL GAME

(71) Applicant: InGameSports Inc., Tacoma, WA (US)

(72) Inventor: Robert Cassis, Tacoma, WA (US)

(21) Appl. No.: 18/364,343

(22) Filed: Aug. 2, 2023

(51) Int. Cl. G07F 17/32; G06Q 50/34

(52) U.S. Cl. CPC G07F 17/3288; G06Q 50/34

(57) ABSTRACT

A facility receives input predicting an intermediate result in a sports contest in progress, which includes an outcome predicted for a portion of the contest that is underway, and a number of points committed for the prediction. Where the committed number of points is no greater than an uncommitted point balance, the facility accepts the prediction. It reduces the uncommitted point balance by the committed number of points, and displays an indication of the first prediction. The facility determines whether the outcome predicted for the distinguished possession was satisfied by the distinguished possession. Where it is, the facility adds a reward number of points based on the committed number of points committed to a total point balance, and adds the reward number of points and the committed number of points to the uncommitted point balance. Otherwise, the facility subtracts from the total point balance the committed number of points.

### BACKGROUND

American football (“football”) is played at many levels, including professional, college, high school, and junior high. Many football games are the subject of live broadcasts, such as via broadcast television, cable television, satellite television, Internet streaming, and radio.

As described in American football rules, available at en.wikipedia.org/wiki/American_football_rules, gameplay in American football consists of a series of downs, individual plays of short duration, outside of which the ball is dead or not in play. These can be plays from scrimmage—passes, runs, punts or field goal attempts (from either a place kick or a drop kick)—or free kicks such as kickoffs and fair catch kicks.

The objective of this game is to score more points than the other team during the allotted time. The team with the ball (the offense) has 4 plays (downs) to advance at least 10 yards, and can score points once they reach the opposite end of the field, which is home to a scoring zone called the end zone, as well as the goalposts. If the offense succeeds in advancing at least 10 yards, they earn a “first down” and the number of tries allotted is reset and then they are again given 4 tries to advance an additional 10 yards, starting from the spot to which they last advanced. If the offense does not advance at least 10 yards during their 4 downs, the team without the ball (the defense) regains control of the ball (called turnover on downs).

On offense, points are scored by advancing the ball into the opponent's end zone for a touchdown (worth six points), or by kicking the ball from the playing field through the raised vertical posts (the goalposts) situated on the end line of the end zone for a field goal (worth three points). After scoring a touchdown, the offense is given an additional opportunity from the 2-yard line (3-yard line in amateur football) to attempt to score (in the NFL, 15-yard line on 1-point conversions). Conversion attempts are used to score 1 or 2 points as follows: the offense may attempt a field goal kick which is worth 1 point; the offense may attempt to re-advance the ball into the opponent's end zone for a two-point conversion worth 2 points.

While the opposing team has possession, the defense attempts to prevent the offense from advancing the ball and scoring. If an offensive player loses the ball during play (a fumble) or the ball is caught by a defensive player while still in the air (an interception), the defense may attempt to run into the offense's end zone for a touchdown. The defense may also score points by tackling the ball carrier in the offense's own end zone, called a safety (which is worth two points).

### BRIEF DESCRIPTION OF THE DRAWINGS

FIG. 1 is a network diagram showing a sample environment in which the facility operates in some embodiments.

FIG. 2 is a block diagram showing some of the components typically incorporated in at least some of the computer systems and other devices on which the facility operates.

FIG. 3 is a flow diagram showing a process performed by the facility in some embodiments to operate the game with respect to a single player.

FIG. 4 is a display diagram showing a sample display presented by the facility in some embodiments to determine a local time at which a player client observes a kickoff in a game broadcast.

FIG. 5 is a table diagram showing sample contents of a play table.

FIGS. 6-8 are display diagrams showing a sequence of sample displays presented by the facility in some embodiments to solicit and receive information from a player used to establish a prediction.

FIG. 9 is a table diagram showing sample contents of a prediction table used by the facility in some embodiments to store each prediction made by a player.

FIG. 10 is a display diagram showing a sample display presented by the facility in some embodiments to present the present state of predictions made by player DadSlayer.

FIG. 11 is a table diagram showing sample contents of the play table at a later time

FIG. 12 is a table diagram showing sample contents of a prediction resolution table used by the facility in some embodiments to store information used in resolving each prediction.

FIG. 13 is a display diagram showing sample contents of a display presented by the facility in some embodiments to update the predictions displayed to the player DadSlayer.

FIG. 14 is a table diagram showing sample contents of the prediction table at a later time.

FIG. 15 is a display diagram showing sample contents of a display presented by the facility in some embodiments to provide an updated status of predictions made by the player DadSlayer.

FIG. 16 is a table diagram showing sample contents of the prediction resolution table at a later time.

FIG. 17 is a display diagram showing a display presented by the facility in some embodiments to update the prediction history of the player DadSlayer.

FIG. 18 is a table diagram showing sample contents of the play table at a later time.

FIG. 19 is a table diagram showing sample contents of a prediction resolution table at a later time.

FIG. 20 is a display diagram showing sample contents of a display presented by the facility in some embodiments to update the prediction history for the player DadSlayer.

### DETAILED DESCRIPTION

The inventors have observed that many fans of football enjoy watching (and/or listening to) games as they unfold, either in person, or via live broadcasts. They have recognized that this experience could be enhanced by providing a companion game to play while watching or listening-such as on a mobile device—that engages the fan in the details of the football game.

In response to recognizing this opportunity, the inventors have conceived and reduced to practice a software and/or hardware facility for playing a game to predict intermediate results of a sporting contest, such as the result of a current or near-future possession in a football game (“the facility”).

In some embodiments, the facility enables a user to submit predictions about the outcome of the current possession. Each prediction specifies an outcome for the possession-such as the broad category of offensive score, or the individual types of offensive scores, touchdown and field goal—as well as a number of points committed to the prediction, from among a point balance maintained by the facility for the user. In some embodiments, instead of or in addition to making predictions about the outcome of a possession, the user can submit predictions for the outcome of portions of the game of various other types and timescales, such as for a play, a portion of a play, a single set of downs, a game quarter, or a game half. If the prediction proves accurate, the number of points committed in the prediction, adjusted by the probability of the outcome, is added to the user's point balance. If the prediction proves inaccurate, the number of points committed in the prediction is subtracted from the user's point balance.

In some embodiments, the user can compete with others based upon point balance, including friends or celebrities. In some embodiments, the user can join a team or other group, in which case the user's point balance inures to that group as part of its competition with other groups. In some embodiments, the user can choose to oppose a team or other group, in which case the user's point balance is subtracted from an aggregate point balance for the group. In some embodiments, the user can add or refill points to their point balance, such as by making a small payment or watching an advertising message.

In some embodiments, the facility determines the number of points to award for a successful prediction by dividing the committed number of points by a probability it determines for the predicted outcome. In particular, the facility uses an effective time assigned to the prediction to determine the game situation that existed at the effective time, such as down number, number of yards to a first down, and number of yards from the line of scrimmage to the goal line. In some embodiments, this information is inputted by an observer engaged by the facility to watch the game and record game situation information for each play, together with the snap time at which each play begins. In some embodiments, the percentage of times that the predicted outcome has occurred in the same or similar game situations is used as the probability that it will occur in the present drive.

In some embodiments, the facility determines the effective time of each prediction using a time offset determined for the user making the prediction. In some cases, the facility asks the user to click a button at the moment when the game's kickoff occurs in the broadcast they are watching. The facility compares this user kickoff time to an observer kickoff time to determine a time offset for the user. In various embodiments, the user's time offset is aggregated with those of other users, such as other users in the same ZIP code or other geographic area, other users who are viewing it broadcast in the same modality or by the same provider, etc. Even where the user does not use the button to indicate kickoff time, in some embodiments the user receives a time offset based upon the time offsets of similarly-situated users that enables them to submit predictions.

In various embodiments, the facility distributes various aspects of the processing described above between physical or virtual servers, player client devices, and/or observer client devices.

In some embodiments, the facility assigns a special time offset to users whose geographic locations are close enough to the geographic location at which the game is being played to be able to directly view in real time the game or a scoreboard showing game situation.

In some embodiments, in addition to submitting predictions about the current possession, the user can also submit predictions about upcoming possessions, such as the next possession of the team that is presently on defense.

By operating in some or all of the ways described above, the facility enhances its users' enjoyment of live sports contests in a way that increases engagement with the game and enjoyable interactions with other fans.

Additionally, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by determining the game situation at each prediction's effective time in a backend server, the facility avoids using processing resources on the client device that would otherwise be needed to solicit and receive game situation information in connection with each prediction, and network capacity that would be needed to send this game situation information to the backend.

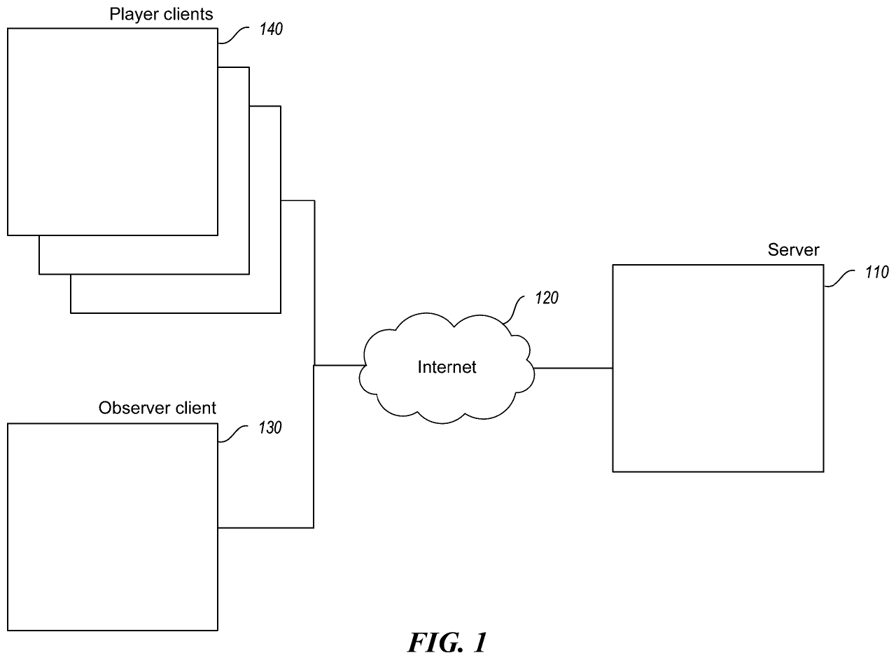

FIG. 1 is a network diagram showing a sample environment in which the facility operates in some embodiments. Code that is part of the facility runs on one or more servers 110. Via the internet 120 or another geographically-broad data network, the server interacts with an observer client 130. One or more people, referred to herein as observers, interact with the observer client to input information about a football game or other athletic contest during the time it is being played. This information includes data describing the game situations that arise over time during the athletic contest, such as the offensive team, down, yards to go for a first down, and yards to go to the goal line for each offensive play in a football game. This data describing game situations is time-indexed, based upon a clock on the observer client that reflects the time at which the observer inputs this information about game situations, which can reflect a broadcast delay of the broadcast that the observer is using to observe the game. In some cases, the observer client also provides to the server synchronization information that allows times determined based upon the clock of the observer client to be synchronized with times determined by player clients, and reconcile differences in the delay time between the broadcasting observed by the observer and the broadcasting observed by each player. When a portion of the contest that is the subject of predictions—such as an offensive drive in football—is completed, the observer reports the completion of the portion and its outcome via the observer client.

The player clients 140 also interact with the server via the network, and provide to the server information about predictions made by the player using each player client, committing a certain portion of the player's point balance to predicting an outcome for a current portion of the athletic contest, such as a current offensive drive in a football game. In some embodiments, the players can also use the player clients to make predictions about future portions, such as the next offensive drive by the team who does not currently have possession. The server uses the information it receives from the observer client and the player clients to track and resolve each prediction, and update point balances on behalf of the players. It provides versions of this information to each player client to reflect the outcome of the player's predictions and the player's updated point balance. Periodically, the server also uses each player's point balance to update point totals for groups of players, such as by adding a player's point balance to the total for a group to which the player belongs, and/or subtracting the player's point balance from the total for a group that the player opposes. In some embodiments, the facility compares the player's point balance against that of another player with whom the player is competing head-to-head, such as a celebrity player.

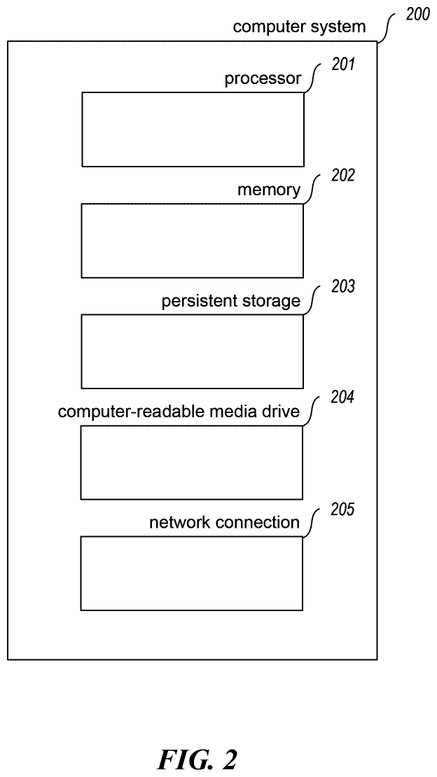

FIG. 2 is a block diagram showing some of the components typically incorporated in at least some of the computer systems and other devices on which the facility operates, including those shown in FIG. 1. In various embodiments, these computer systems and other devices 200 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 201 for executing computer programs and/or training or applying machine learning models, such as a CPU, GPU, TPU, NNP, FPGA, or ASIC; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

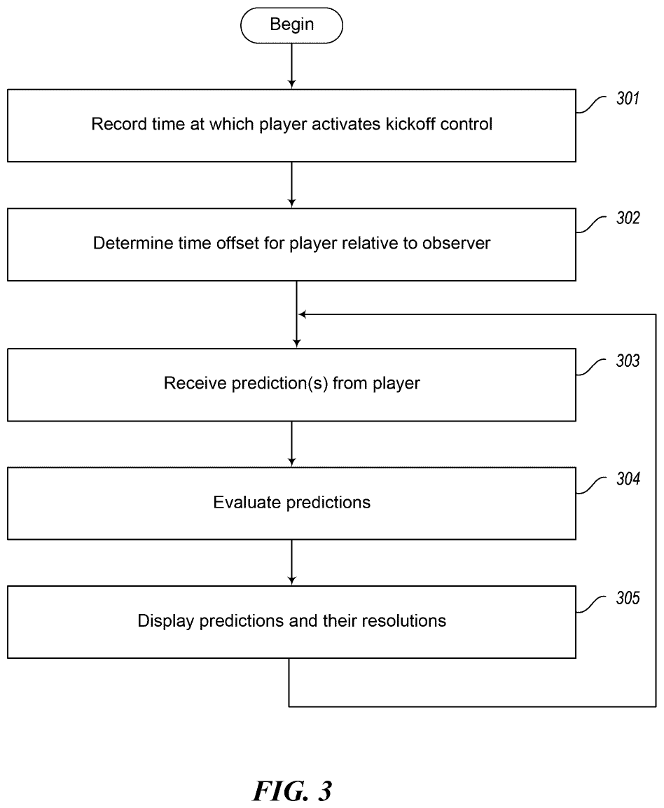

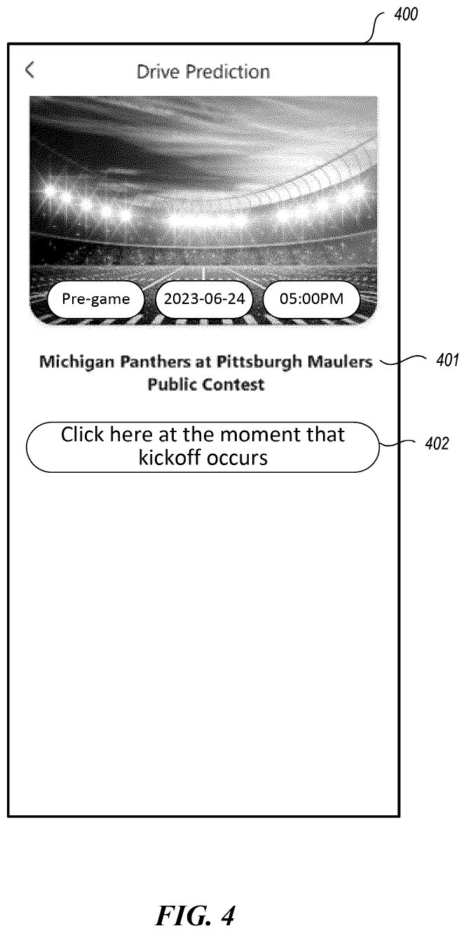

FIG. 3 is a flow diagram showing a process performed by the facility in some embodiments to operate the game with respect to a single player. In act 301, the facility records a time, as reflected by the system clock of the player client, at which the player activates a kickoff control to indicate that the kickoff—such as a kickoff starting the first half or the second half of a football game—is presently occurring. Such a kickoff control is shown in FIG. 4, discussed below. In act 302, the facility determines a time offset for the player relative to the observer who is recording the game situation associated with each offensive play, as well as the snap time that begins that play and ends that game situation. In some embodiments, the facility does this by having the observer activate a similar kickoff control, recording the system time on the observer client at which the observer activates the kickoff control, and subtracting the player kickoff time from the observer kickoff time. In some embodiments, the facility aggregates the player's kickoff time with those of other players who are similarly situated. In various embodiments, similar situation involves having the same broadcast modality, e.g., radio, broadcast television, cable television, satellite television, internet streaming, etc.; having the same provider of that modality, such as a particular broadcast television network, a particular internet streaming service, a particular cable television provider, etc.; a particular geographic region, such as a telephone area code, or a postal zip code, a county, or a state. In various embodiments, the facility uses various particular techniques with respect to this aggregation, such as excluding kickoff times that are not within two standard deviations, and using the mean, median, or mode of the remaining kickoff times. In some embodiments, rather than using kickoff controls as shown, the facility uses another mechanism for time synchronization, such as using audio input devices of the observer client and player clients to listen for matching audio sequences, including those commonly arising at the beginning of the game, and calculating the time offset based upon these. In some embodiments, if a player starts playing the game at a time after a time offset is determined for other players, the facility associates the player with the most appropriate group of players, and assigns to the player the time offset from that group.

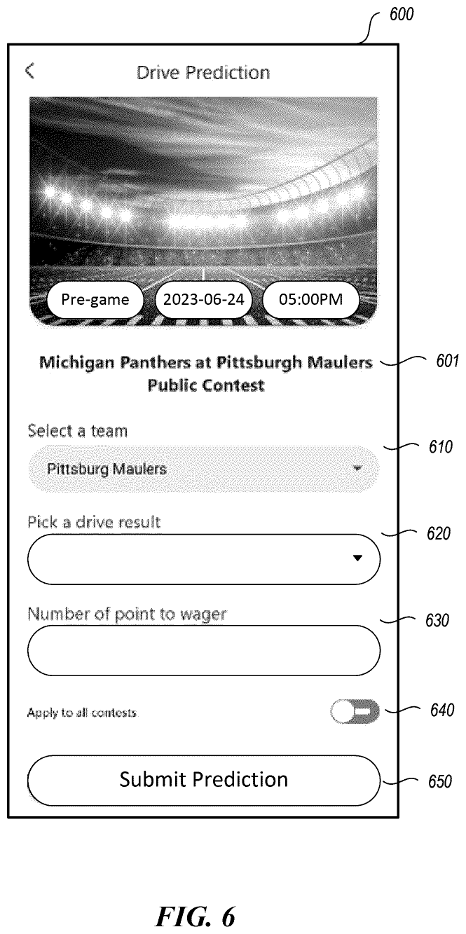

In act 303, the facility receives one or more predictions from a player. For example, FIGS. 6-8 show an example of receiving a prediction from a player. In act 304, the facility evaluates the predictions, as play situations and drive resolutions are received from the observer client that affect received predictions. In act 305, the facility displays the predictions made by the player and their resolutions, including updating the point balance for the player to reflect outcomes for the predictions. After act 305, the facility continues in act 303.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 4 is a display diagram showing a sample display presented by the facility in some embodiments to determine a local time at which a player client observes a kickoff in a game broadcast. The display 400 includes information 401 identifying the game, and a control 402 that can be activated by the player to identify the time at which the kickoff occurs in the broadcast of that game that the player is observing. In various embodiments, the player can touch the control, click on the control, speak one or more of the words displayed in the control, etc.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, revisualized, or shown at different levels of magnification, etc.

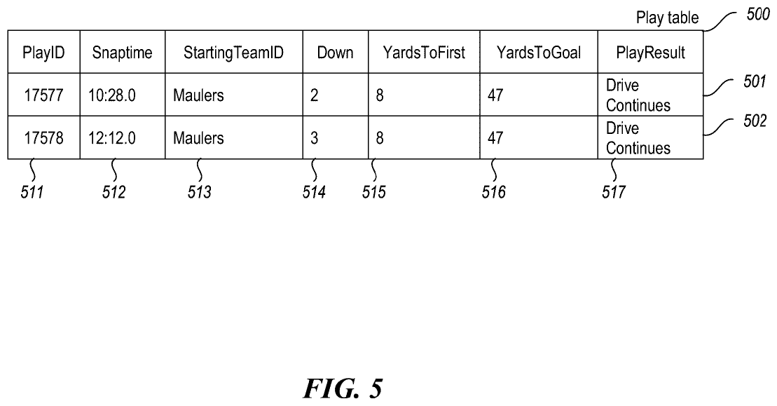

In some embodiments, the facility maintains a play table to contain information received from the observer about each play of a game. FIG. 5 is a table diagram showing sample contents of the play table. Play table 500 is made up of rows, such as rows 501 and 502, each corresponding to a different play during the game. Each row is divided into the following columns: a play identifier (i.e., “PlayID”) column 511 containing an identifier uniquely identifying the play within the game; a Snaptime column 512 specifying a time at which a snap occurred, ending the game situation that is described in the remainder of the row; a StartingTeamID column 513 that shows the offensive team that snapped the ball for the play; a Down column 514 that shows the down at the time the play began; a YardsToFirst down column 515 that shows the number of yards from the play's line of scrimmage to the first down marker; a YardsToGoal 516 column showing the number of yards from the line of scrimmage to the goal line toward which the play is progressing; and a PlayResult column that shows any resolution of the current drive that occurred after the play. For example, row 501 shows that the play having PlayID 17577 had a snap time of 10:28.0 on the observer client; the offensive team was the Maulers; the play began at second down with eight yards to go for a first down and 47 yards to the goal line; and the result of the play was that the Maulers did not score and retained possession.

In some embodiments (not shown), the facility receives from the observer and stores in the play table additional details about game state, which can in some cases correspond to shorter periods of time than an entire play. These can include, for example, that players are lining up for the snap, the play clock is running or not running, the play was a completed pass, the play was a run for gain, the play was a run for loss, etc. (not shown). This more detailed game state information supports player predictions about the outcome of a play instead of or in addition to the outcome of a drive.

While FIG. 5 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

FIGS. 6-8 are display diagrams showing a sequence of sample displays presented by the facility in some embodiments to solicit and receive information from a player used to establish a prediction. The displays shown in FIGS. 6-8 are presented to the player Crabman, who interacts with them in order to submit a prediction.

FIG. 6 shows a first display 600 in the sequence. The display includes information 601 identifying the game for which the prediction is being made. The display has a control 610 for selecting one of the two teams who are playing whose offensive possession is the subject of the prediction; a control 620 that can be used to select a predicted result for the drive underway by the offensive team or the next drive by the present defensive team; and a control 630 for specifying the number of points to be committed to the prediction. It can be seen that the user has used control 610 to select the Pittsburgh Maulers as the subject of the prediction.

FIG. 7 shows a second display diagram 700 of this sequence. It can be seen that the user has selected control 620 shown in FIG. 6, causing the facility to expand a list of possible drive results (otherwise known as “outcome types” for the drive that is the subject of the prediction) 761-771. In the example, the user selects drive result 761, “Offensive Score,” which is satisfied if the drive is ended by either a touchdown 762 or a field goal 763. Another high-level drive result 764, “defensive stop,” is satisfied if the drive is ended by a punt 765, a missed field goal 766, a fumble 767, an interception 768, a turnover on downs 769, a safety 770, or time expired 771. In some embodiments, the following play results are available to select for a prediction: pass for gain, pass for touchdown, pass for loss or no gain, pass for interception, pass for interception for touchdown, spiked ball, pass for safety, run for gain, run for touchdown, run for loss or no gain, run for fumble, run for fumble for touchdown, run for safety, field goal, missed field goal, missed field goal returned for touchdown, punt returned, punt fair caught, punt returned for touchdown, punt with fumble, punt with fumble returned for touchdown, kickoff returned, kickoff fair caught, kickoff returned for touchdown, kickoff out of the endzone, kickoff fumble, and kickoff fumble returned for touchdown.

FIG. 8 is a third display diagram 800 in the sequence. It can be seen that the player's selection of offensive score 761 in FIG. 7 has resulted in offensive score appearing in control 820. The user has additionally typed the number 10 into control 830 to specify that number of points to commit to the prediction. In some embodiments in which the user can within the game enroll in multiple contests that all relate to the same in-progress football game, the user can additionally activate control 840 to select that this prediction will be submitted in all of the contests in which the user is enrolled. After completing this information, the user activates a submit prediction control 850 to submit a prediction that the Pittsburgh Maulers, who presently have the ball, will end their present drive with an offensive score, to which the user is committing ten points.

In the example, the user DadSlayer uses the same sequence of displays shown in FIGS. 6-8 to submit the same prediction as the player Crabman at a later time (not shown).

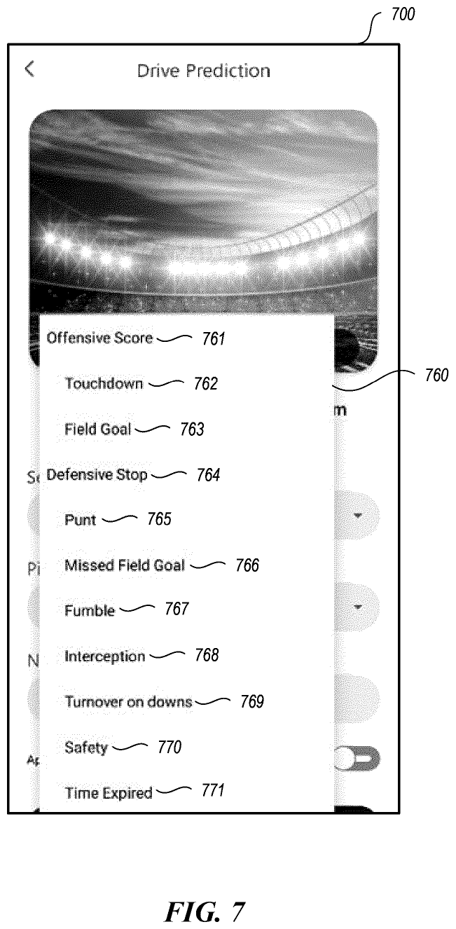

FIG. 9 is a table diagram showing sample contents of a prediction table used by the facility in some embodiments to store each prediction made by a player. The prediction table 900 is made up of rows, such as rows 901 and 902, each corresponding to a single prediction by a particular player. Each row is divided into the following columns: a UserName column 911 identifying the user who made the prediction; a PredictionID column 912 uniquely identifying the prediction; a PredictionTime column 913 showing the time on the player client's system clock when the prediction was submitted; a SnapOffsetSeconds column 914 showing a time offset used to synchronize prediction submission events on the player client with snap events on the observer client; an EffectivePredictionTime column 915 containing an effective time assigned to the prediction on the basis of the local prediction time and the synchronization offset; a PredictionOffensiveTeam column 916 indicating which team will be on offense for the possession that is the subject of the prediction; a PredictedDriveResult column 917 containing the outcome predicted for the possession; and a CommittedPoints column 918 showing the number of points committed to the prediction. For example, row 902 represents a prediction made by the player DadSlayer, assigned PredictionID 2053. The prediction was submitted at 12:53.1 on the player client's system clock, adjusted by a synchronization offset of 67 seconds to an effective prediction time of 11:46.1 for comparison with the snap time of each play recorded by the observer. The prediction predicts that the Maulers will end their present or next upcoming possession with an offensive score, and 10 points are committed to the prediction.

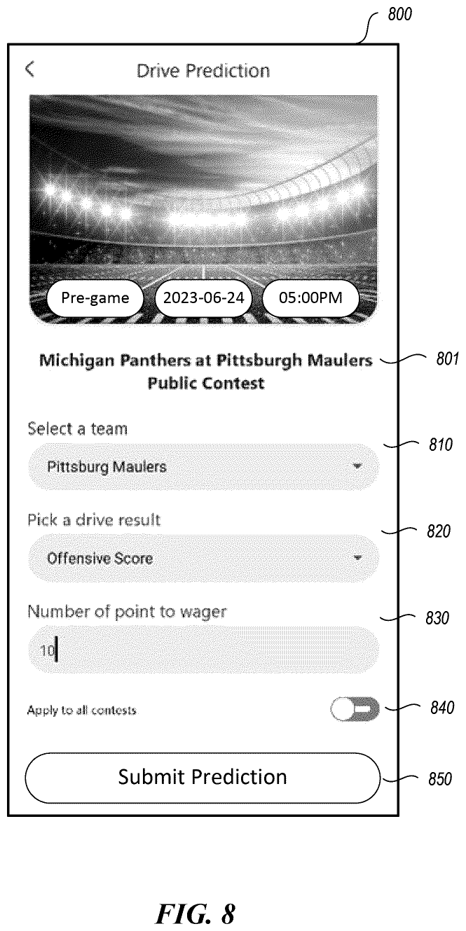

FIG. 10 is a display diagram showing a sample display presented by the facility in some embodiments to present to player DadSlayer the present state of predictions made by him. The display 1000 contains information 1001 identifying the football game, as well as row 1010 representing this player's first prediction, including team 1011, predicted outcome 1012, points committed 1013, and points awarded 1014. As shown, row 1010 corresponds to row 901 in prediction table 900 shown in FIG. 9, and indicates that the number of points that will be awarded if the prediction succeeds is presently unknown.

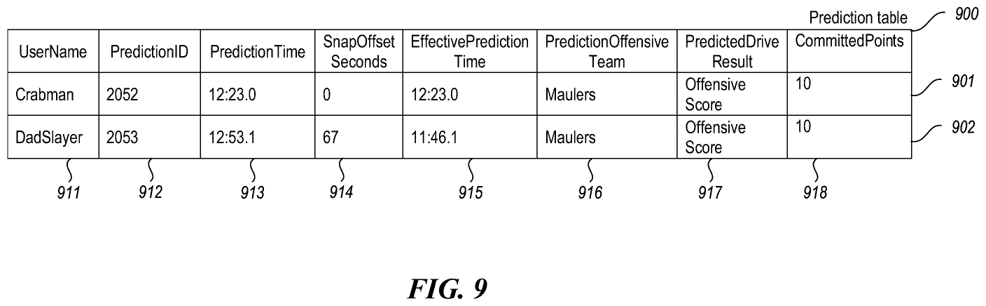

FIG. 11 is a table diagram showing sample contents of the play table at a later time The play table 1100, in addition to containing rows 1101 and 1102 corresponding to rows 501 and 502 shown in FIG. 5, also contains a new row 1103 corresponding to a play in which the Maulers, on third down, advanced the ball 31 yards for a first down.

Every time a play is observed, the facility evaluates the outstanding predictions to determine the situation on the field when they were made. That situation is described by the play that starts next after the effective time of the prediction. Specifically, the game situation recorded for the play describes the starting situation for that play. Now that the play shown in row 1103 and its game situation have been recorded, the facility can associate both of the outstanding predictions with a specific play.

Prediction 2052 occurred at an effective time of 12:23.0 UTC. That is after play 17578 (12:12.0 UTC) and before play 17579 (12:56.0 UTC). The facility associates prediction 2052 to play 17579. Play 17579 has a starting situation of being first down, ten yards to go for a first and 16 yards for a touchdown. The probability for that resulting in an offensive score (what was predicted) is 0.84960. 10 points were committed, and the potential points are computed. Because the situation is extremely likely, the user only stands to receive 11 points if the prediction is correct. In some embodiments, the formula for computing the potential points is the number of committed points divided by the probability.

Prediction 2053 occurred at an effective time of 11:46.1 UTC. That is after play 17577 (10:28.0 UTC) and before play 17578 (12:12.0 UTC). The facility associates prediction 2053 to play 17578. Play 17578 has a starting situation of being third down, 8 yards to go for a first and 47 yards for a touchdown. The probability for that resulting in an offensive score (what was predicted) is 0.41770. 10 points were committed, and the potential points are computed. Because the prediction is less likely in the context of this situation, the user will receive 23 points if the prediction is correct.

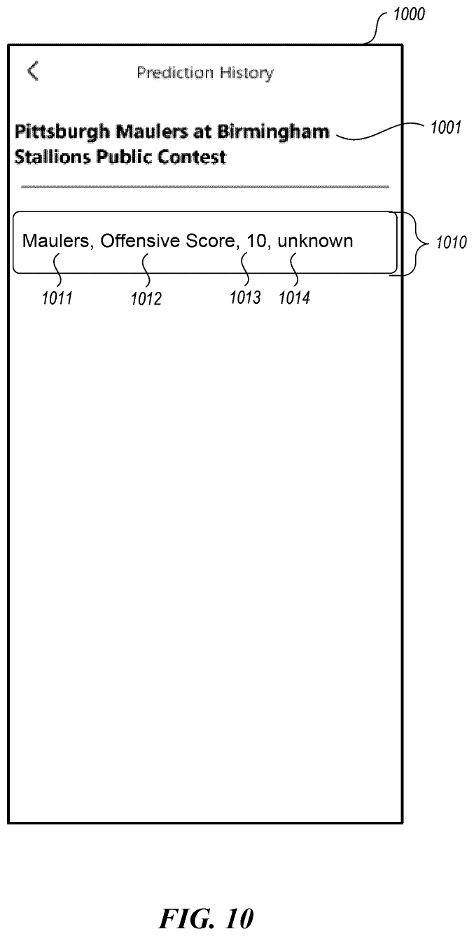

FIG. 12 is a table diagram showing sample contents of a prediction resolution table used by the facility in some embodiments to store information used in resolving each prediction. The table is made up of rows such as 1201 and 1202, each corresponding to a particular prediction that occurs in the prediction table. Each row is divided into the following columns: a PredictionID column 1211 containing a prediction ID used in the prediction table to identify the prediction; a prediction resolution (“PRID”) column 1212 containing an identifier used to uniquely identify this row of the prediction resolution table; an AsOfPlayID column 1213 containing the PlayID of the first play whose snap occurred after the effective time of the prediction; a ResolvingPlayID column 1214 containing the PlayID of the play that resolved the prediction; a PotentialPoints column 1215 containing the number of points that will be awarded if the predicted outcome occurs, based upon the number of points committed and the likelihood of the outcome occurring based upon the game situation that existed at the time the play snap occurred; and an ActualPoints column 1216 containing a number of points awarded when a prediction is ultimately resolved. For example, row 1201 indicates that the prediction represented by row 902 in the prediction table shown in FIG. 9 and having PredictionID 2053 is the subject of row 1201, which is identified by prediction resolution ID 2398. Based upon its local prediction time, the player's synchronization offset, and the observer's snap times for the plays, the facility has assigned this prediction to the play represented by row 1102 of the play table shown in FIG. 11 having PlayID 17578. Because the prediction has not been resolved, the resolving PlayID and ActualPoints columns both contain a null value. As described above, the facility has calculated the award number of points of 23 for this prediction.

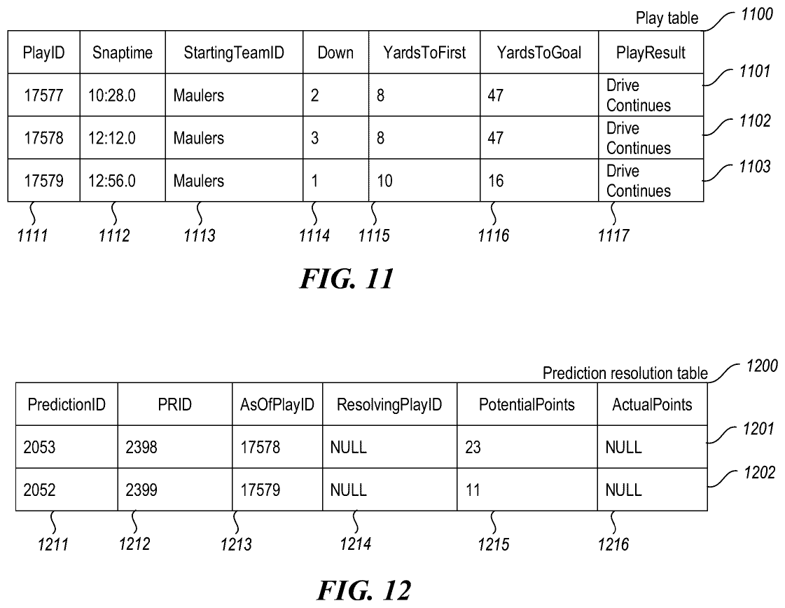

FIG. 13 is a display diagram showing sample contents of a display presented by the facility in some embodiments to update the predictions displayed to the player DadSlayer relative to FIG. 10. In particular, the facility has updated row 1510 to show a number of potential points of 11, corresponding to row 1202 of the prediction resolution table.

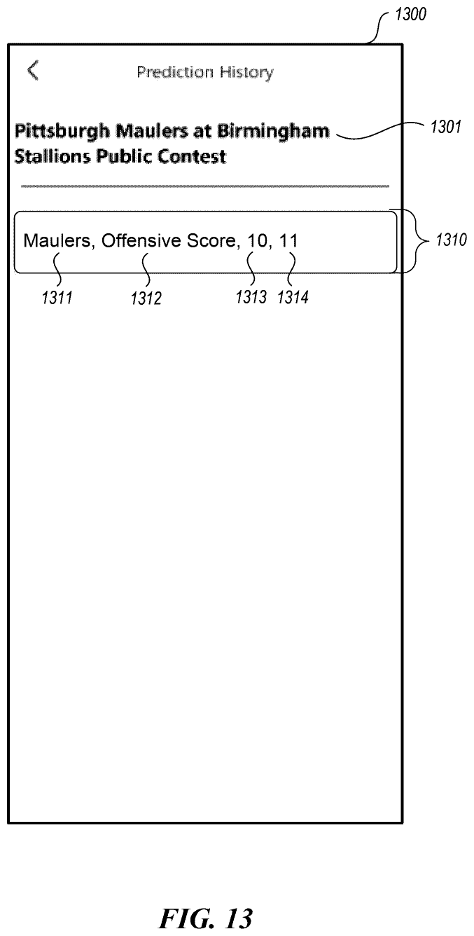

FIG. 14 is a table diagram showing sample contents of the prediction table at a later time. In addition to rows 1401 and 1402 contained by the prediction table shown in FIG. 9 at an earlier time, the facility has added row 1403 to represent a new prediction made by the player DadSlayer. The prediction is that the other team, the Panthers, which is presently on defense, will end their next possession by punting. The player committed 15 points to this prediction, and made it at a local time of 13:13.3, which, when adjusted by the synchronization offset of 67 seconds, receives an effective prediction time of 12:06.3.

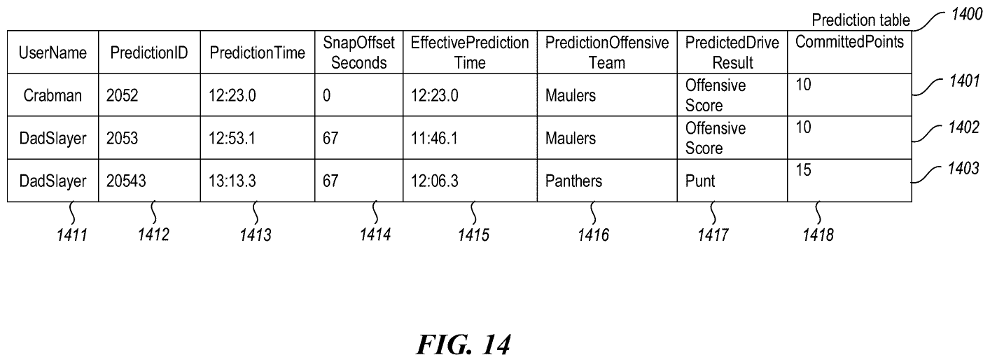

FIG. 15 is a display diagram showing sample contents of a display presented by the facility in some embodiments to provide an updated status of predictions made by the player DadSlayer. It can be seen that, relative to FIG. 13, the facility has added row 1520, representing the prediction that the Panthers will punt in their next possession, to which 15 points have been committed.

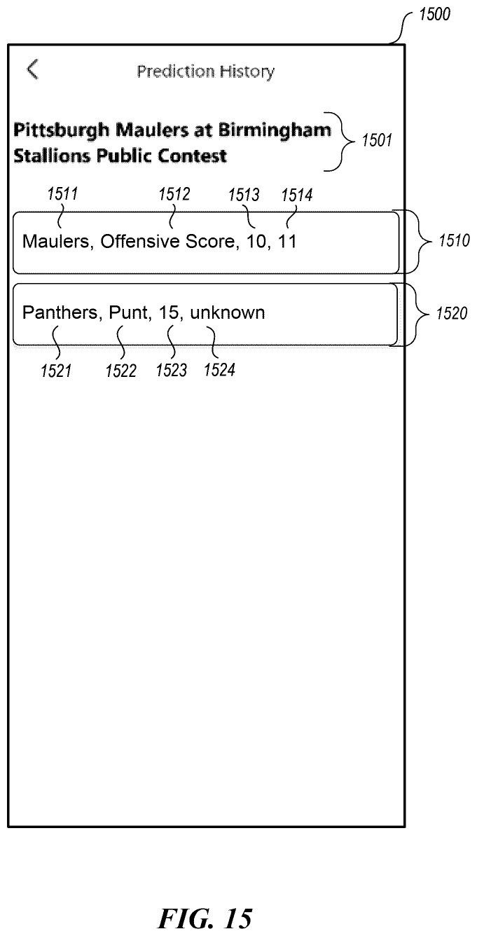

FIG. 16 is a table diagram showing sample contents of the prediction resolution table at a later time. In particular, relative to the earlier version of the prediction resolution table shown in FIG. 12, the facility has added row 1603, corresponding to the new prediction discussed above in connection with FIGS. 14 and 15.

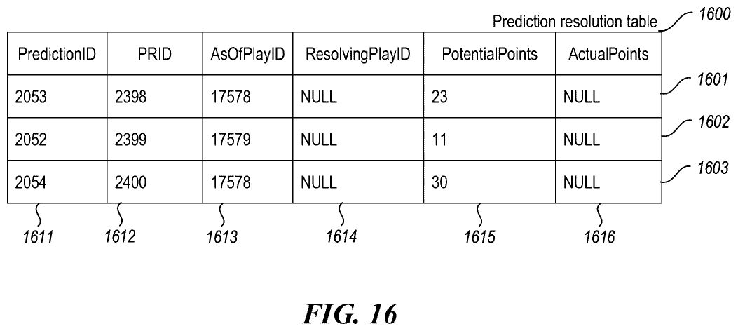

FIG. 17 is a display diagram showing a display presented by the facility in some embodiments to update the prediction history of the player DadSlayer. In particular, the facility has added to row 1720 a number of potential points equal to 30, taken from row 1603 of prediction resolution table 1600 shown in FIG. 16. Finally, a play is recorded by the observer that resolves the predictions. The Maulers score a field goal, which fulfills the outcomes of Field Goal and Offensive Score.

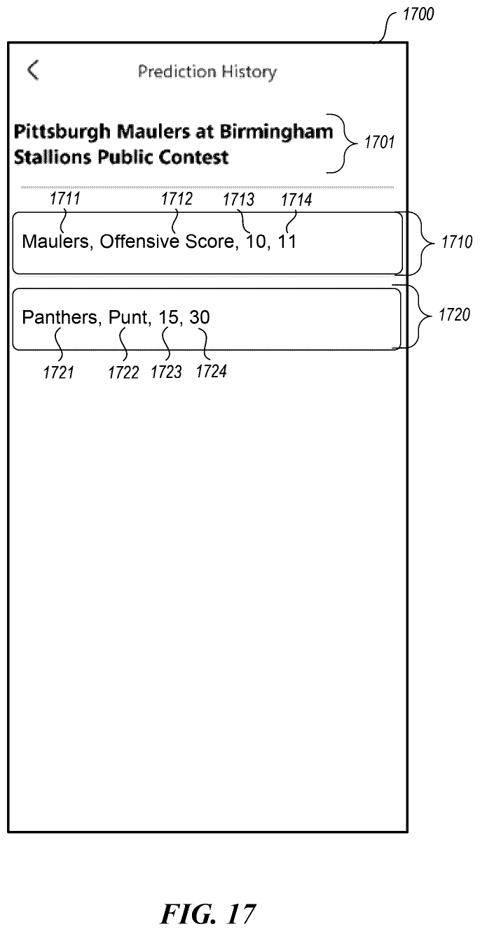

FIG. 18 is a table diagram showing sample contents of the play table at a later time. In particular, the play table 1800 contains new row 1804 representing the play in which the Maulers kick a field goal. At this point all predictions for the Maulers possession are resolved, and points are awarded to any correct predictions. Statistics are computed and standings are updated.

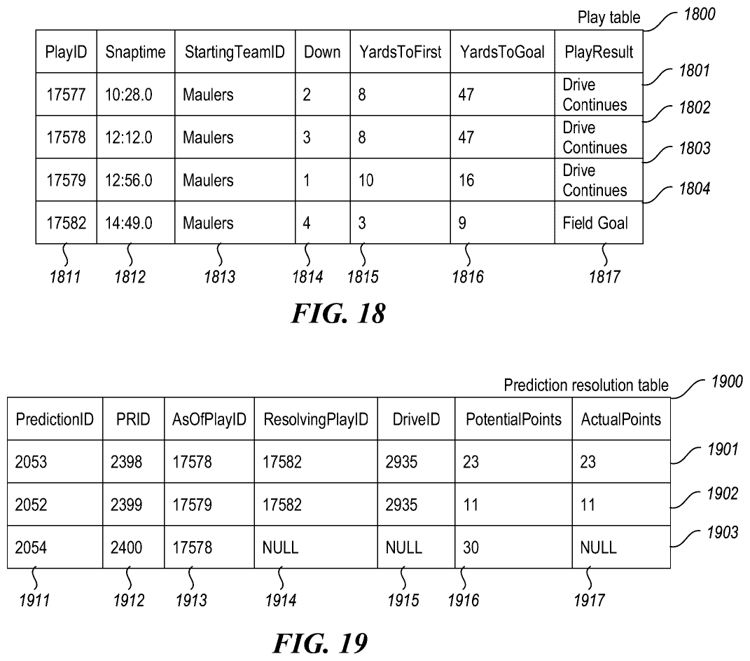

FIG. 19 is a table diagram showing sample contents of a prediction resolution table at a later time. In particular, relative to FIG. 16, the facility has populated the DriveID column 1915 and the ActualPoints columns 1917 for the plays represented by rows 1901 and 1902, awarding the potential points in response to both predictions because they succeeded. Because the new possession just begun by the Panthers has not been resolved, these columns are null for row 1903 corresponding to the prediction with respect to the Panthers.

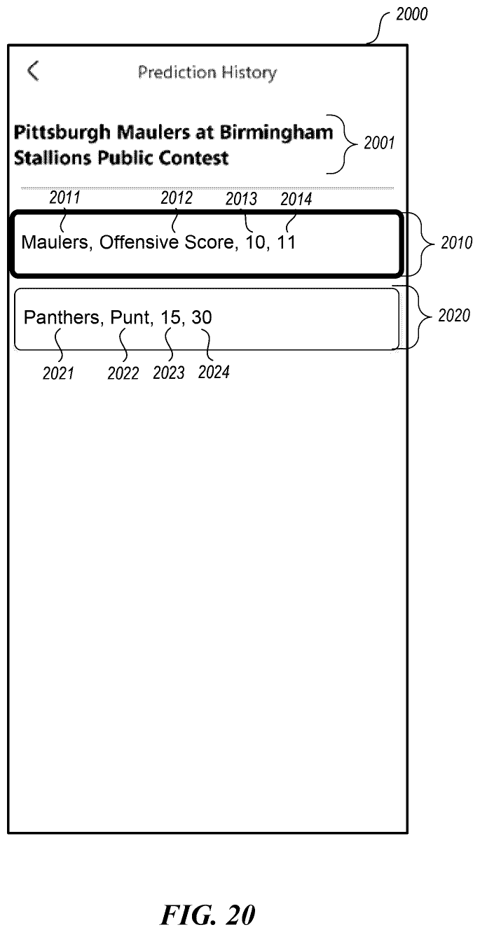

FIG. 20 is a display diagram showing sample contents of a display presented by the facility in some embodiments to update the prediction history for the player DadSlayer. In particular, the facility has added a dark green rectangle around row 2010 to indicate that this prediction was correct. Had the prediction failed, the facility would have added a dark red rectangle around row 2010 to reflect the failure of the prediction (not shown). In some embodiments (not shown), the facility further displays a number of points for the player DadSlayer that have been increased by 11 points to reflect the correctness of the prediction.

Note that because of the delays of when users observe a game, a prediction may come in AFTER the drive has been evaluated. To handle that situation, in some embodiments, the facility recomputes the predictions and drive results (with statistics) after each play is received from the observer. In some embodiments, the facility waits to resolve the drive until the largest observation delay of any of the users has passed.

In some embodiments, rather than or in addition to receiving information about the athletic competition over the course of its duration from an observer under the control of the operator of the facility, the facility receives such information from a third-party service, in either a push or pull model.

In some embodiments, the facility evaluates prediction situations only upon drive completion. In this approach, potential points are not available for user display, and the users must wait for a full second drive to complete before any predictions are resolved that were entered after the drive results were processed.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing device operated by a player, comprising:
causing to be displayed a prompt soliciting a prediction of an intermediate result with respect to a football game in progress;
receiving first input specifying a first prediction, the prediction comprising:
an outcome category predicted for a distinguished possession underway in the football game; and
a number of points committed for the first prediction;
where the number of points committed for the first prediction is no greater than an uncommitted point balance of the player:
reducing the uncommitted point balance of the player by the number of points committed for the first prediction;
causing to be displayed an indication of the first prediction;
at a time after the distinguished possession concludes:
determining whether the outcome category predicted for the distinguished possession was satisfied by the distinguished possession;
where the outcome category predicted by the first prediction for the distinguished possession was satisfied by the distinguished possession:
adding a reward number of points based at least in part on the number of points committed for the first prediction to a total point balance of the player;
adding the reward number of points and the number of points committed for the first prediction to the uncommitted point balance of the player;
where the outcome category predicted by the first prediction for the distinguished possession was not satisfied by the distinguished possession:
subtracting from the total point balance of the player the number of points committed for the first prediction; and
causing the total point balance of the player as affected by the adding or subtracting to be displayed.

2. The method of claim 1 wherein the predicted outcome category is offensive score, touchdown, field goal, defensive stop, punt, missed field goal, fumble, interception, turnover on downs, safety, or time expired.

3. The method of claim 1 wherein the predicted outcome category is pass for gain, pass for touchdown, pass for loss no gain, pass for interception, pass for interception for touchdown, spiked ball, pass for safety, run for gain, run for touchdown, run for loss no gain, run for fumble, run for fumble for touchdown, run for safety, field goal, missed field goal, missed field goal returned for touchdown, punt returned, punt fair caught, punt returned for touchdown, punt with fumble, punt with fumble returned for touchdown, kickoff returned, kickoff fair caught, kickoff returned for touchdown, kickoff out of the endzone, kickoff fumble, or kickoff fumble returned for touchdown.

4. The method of claim 1 wherein a first team and a second team are playing in the football game, and wherein the first team is on offense for the distinguished possession,
the method further comprising:
receiving second input specifying a second prediction, the second prediction comprising:
an outcome category predicted for a further possession following the distinguished possession underway in the football game, the further possession being the first possession after the distinguished possession in which the second team is on offense; and
a number of points committed for the second prediction.

5. The method of claim 1, further comprising:
determining the reward number of points by dividing the number of points committed by a numerical measure of the ease of predicting that the predicted outcome category will occur for the distinguished possession.

6. The method of claim 5, further comprising:
determining an effective time for the first prediction;
determining a game situation that exists in the game at the effective time; and
determining the numerical measure of the ease of predicting that the predicted outcome category will occur for the distinguished possession by determining an aggregate rate at which the predicted outcome category occurs among possessions in a set of earlier games whose game situations are similar to or the same as the determined game situation.

7. The method of claim 6 wherein the determined game situation comprises a down number, a yards-to-first-down distance, and a yards-to-goal distance.

8. The method of claim 6 wherein the determined game situation further comprises any of an amount of time left on the game clock, a number of time outs remaining for the first team, whether the first team has a larger score than the second team, and a margin between the first team's score and the second team's score.

9. The method of claim 6 wherein the determined game situation further comprises any of a rank of the first team and a record of the first team.

10. The method of claim 6 wherein the first and second teams are both in a league, and the set of earlier games are games played by teams in the league.

11. The method of claim 6 wherein the set of earlier games are games played by the first team.

12. The method of claim 6, further comprising using Markov chain analysis to predict a probability that the predicted outcome category will occur based on the determined aggregate rate.

13. The method of claim 6 wherein the computing device has a first system clock, and wherein a second computing device used by an observer has a second system clock, the method further comprising:
using the first system clock to determine a second time at which first broadcast synchronization input based on a broadcast being observed by the player is received by the computing device is received;
using the second system clock to determine a third time at which second broadcast synchronization input based on a broadcast being observed by the observer is received by the second computing device is received;
subtracting the second time from the third time to obtain a time offset;
adding the obtained time offset to the first time to obtain the effective time for the first prediction;
identifying a play number of a play that began with the first snap that occurred in the broadcast being observed by the observer after the effective time for the first prediction; and
determining the game situation specified by the observer for the identified play number.

14. The method of claim 13 wherein the first broadcast synchronization input activates a kickoff control displayed by the computing device,
and wherein the second broadcasting position input activates a kickoff control displayed by the second computing device.

15. The method of claim 13 wherein the first broadcast synchronization input activates is a first audio pattern received by an audio input of the computing device, and wherein the second broadcast synchronization input activates is a second audio pattern matching the first audio pattern received by an audio input of the second computing device.

16. The method of claim 5, further comprising:
determining an effective time for the first prediction; and
determining the numerical measure of the ease of predicting that the predicted outcome category will occur for the distinguished possession based on predictions received from computing devices operated by other players received at similar times that predict the same outcome category.

17. One or more instances of computer-readable media collectively having contents configured to cause a computing system having a system clock to perform a method, the method comprising:
for each snap of a football game being observed via a broadcast,
receiving first input indicating that the snap is presently occurring in the broadcast;
using the system clock to determine a first time at which the first input is received;
receiving second input specifying a game situation that existed at the time of the snap, the game situation comprising:
team with possession,
down number,
distance to first down, and
distance to goal line;
causing a representation of the snap comprising the determined first time and the specified game situation to be transmitted to a server.

18. The one or more instances of computer-readable media of claim 17, the method further comprising:
receiving broadcast synchronization input based on the broadcast;
using the system clock to determine a second time at which the broadcast synchronization input is received; and
causing a broadcast synchronization message containing the determined second time to be sent to the server.

19. One or more instances of computer-readable media collectively storing data structure, the data structure comprising a plurality of entries, each entry corresponding to a prediction submitted with respect to a sports contest and comprising:
first information identifying a player who submitted the prediction;
second information specifying an effective time during the sports contest when the prediction was submitted that affords a basis for determining a game situation when the prediction was submitted;
third information specifying a type of intermediate outcome of the sports contest predicted to occur following the game situation when the prediction was submitted; and
fourth information specifying a number of points committed to the prediction, such that the contents of the data structure are usable to determine, for each prediction, after it is known whether the predicted intermediate outcome type occurred (1) whether the submitting player should be rewarded, and (2) with what number of points.

20. The one or more instances of computer-readable media of claim 19 wherein the sports contest is being conveyed by a plurality of broadcasts, and wherein, for each entry, the effective time specified by the second information has been adjusted to reflect a time differential between a first broadcast being observed by the player identified by the first information and a second broadcast being observed by an observer who specifies times at which the sports contest's game situation changes.

21. The one or more instances of computer-readable media of claim 19 wherein the sports contest is a football game,
and wherein the intermediate outcome types specified by the third information of the entries are offensive drive outcomes.

22. A method in a computing system operated by a player, comprising:
causing to be displayed a prompt soliciting a prediction of an intermediate result with respect to a sports contest in progress;
receiving first input specifying a first prediction, the prediction comprising:
an outcome category predicted for a distinguished portion of the sports contest; and
a number of points committed for the first prediction;
where the number of points committed for the first prediction is no greater than an uncommitted point balance of the player:
reducing the uncommitted point balance of the player by the number of points committed for the first prediction;
causing to be displayed an indication of the first prediction;
at a time after the distinguished portion concludes:
determining whether the outcome category predicted for the distinguished portion was satisfied by the distinguished possession;
where the outcome category predicted by the first prediction for the distinguished portion was satisfied by the distinguished portion:
adding a reward number of points based at least in part on the number of points committed for the first prediction to a total point balance of the player;
adding the reward number of points and the number of points committed for the first prediction to the uncommitted point balance of the player;
where the outcome category predicted by the first prediction for the distinguished portion was not satisfied by the distinguished portion:
subtracting from the total point balance of the player the number of points committed for the first prediction; and
causing the total point balance of the player as affected by the adding or subtracting to be displayed.

23. The method of claim 22 wherein the sports contest is golf, baseball, or football.

24. The method of claim 22, further comprising:
determining the reward number of points by dividing the number of points committed by a numerical measure of the ease of predicting that the predicted outcome category will occur for the distinguished portion.

25. The method of claim 24, further comprising:
determining an effective time for the first prediction;
determining a game situation that exists in the game at the effective time; and
determining the numerical measure of the ease of predicting that the predicted outcome category will occur for the distinguished possession by determining an aggregate rate at which the predicted outcome category occurs among portions of a set of earlier games whose game situations are similar to or the same as the determined game situation.

26. The method of claim 24, further comprising:
determining an effective time for the first prediction; and
determining the numerical measure of the ease of predicting that the predicted outcome category will occur for the distinguished possession based on predictions received from computing devices operated by other players received at similar times that predict the same outcome category.

27. The method of claim 22, further comprising:
receiving second input selecting a first player group; and
causing the total point balance of the player as affected by the adding or subtracting to be added to a group total of the first player group.

28. The method of claim 22, further comprising:
receiving second input selecting a first player group; and
causing the total point balance of the player as affected by the adding or subtracting to be subtracted from a group total of the first player group.
